(19) United States
(12) Patent Application Publication
(10) Pub. No.: US 2013/0247388 A1
(43) Pub. Date: Sep. 26, 2013

(54) CERAMIC CUTTING KNIFE AND METHOD FOR MANUFACTURING SAME

(71) Applicants: Yoshiyuki Kawasumi, Dongguan-city (CN); Takanori Nishihara, Takatsuki-shi (JP)

(72) Inventors: Yoshiyuki Kawasumi, Dongguan-city (CN); Takanori Nishihara, Takatsuki-shi (JP)

(73) Assignee: KYOCERA CORPORATION, Kyoto-shi, Kyoto (JP)

(21) Appl. No.: 13/990,781

(22) PCT Filed: Nov. 30, 2011
(86) PCT No.: PCT/JP2011/077695

§ 371 Date: May 30, 2013

(30) Foreign Application Priority Data
Nov. 30, 2010 (JP) 2010-265925

(51) Int. Cl. B26B 9/00

(52) U.S. Cl. CPC B26B 9/00
USPC 30/345; 76/104.1

(57) ABSTRACT

A ceramic knife and a method for producing the ceramic knife are disclosed. The ceramic knife includes a base member and two layers on the base member. The base member includes zirconia as a main component. The base member further includes a cutting edge and a cutting edge portion that is adjacent area of the cutting edge. Two layers include a first layer and a second layer. The first layer is located at least on the cutting edge portion of the base member, and includes nitride material such as zirconium nitride, silicon nitride and aluminum nitride. The second layer is located on the first layer, and includes diamond-like carbon or DLS.

### TECHNICAL FIELD

The present invention relates to a ceramic cutting knife and a method for producing the same.

### BACKGROUND ART

In recent years, ceramics, particularly zirconia ceramics having good sliding properties and toughness, have been utilized as materials for knife such as a kitchen knife and the like. These ceramic cutting knifes may have surfaces coated with a diamond-like carbon (also referred to as “DLC” hereinafter) film for the purpose of enhancing hardness and sliding properties.

However, when ceramics are directly coated with the DLC film, the DLC film tends to peel from ceramics due to low adhesion of the DLC films because ceramics are not conductors. Therefore, it is known that an underlying layer of a metal such as Ti, Cr, or the like is provided on a surface of ceramic, and a DLC film is formed on the underlying layer (refer to, for example, Patent Literature 1).

### CITATION LIST

### Patent Literature

PTL 1: Japanese Unexamined Patent Application Publication No. 2003-253473

### SUMMARY OF INVENTION

### Technical Problem

However, even when an underlying film of a metal is applied to a zirconia ceramic cutting knife as described in Patent Literature 1, adhesion between ceramic and the DLC film is not satisfactory, and the metal underlying layer may be exposed by polishing a cutting edge due to peeling of the DLC film near the cutting edge. Further, corrosion of the underlying layer may propagate from the vicinity of the knife to the entire of the edged tool, resulting in peeling of the DLC film.

An object of the present invention is to provide a ceramic cutting knife having good hardness, sliding properties, and sharpness.

### Solution to Problem

A ceramic cutting knife according to the present invention includes: a zirconia ceramic base member including a cutting edge portion; a nitride layer formed on a surface of the cutting edge portion; and a diamond-like carbon layer formed on a surface of the nitride layer.

A method for producing a ceramic cutting knife according to the present invention includes: a first step of forming a nitride layer on a surface of a cutting edge portion of a zirconia ceramic base member having the cutting edge portion by a sputtering method or ion implantation method; and a second step of forming a diamond-like carbon layer on a surface of the nitride layer.

### Advantageous Effects of Invention

According to the present invention, a nitride layer is disposed between a zirconia ceramic base member and a DLC layer, and thus adhesion between the zirconia ceramic base member and the DLC layer can be improved. Even when DLC is removed from a cutting edge portion by sharpening an edged tool, propagation of peeling of the DLC film to a portion other than the cutting edge portion can be reduced. Consequently, good hardness and sliding properties can be maintained even in long-term use, a nicked edge or the like can be reduced, and the ease of cutting food can be maintained.

Further, a zirconia ceramic cutting knife having high bending strength due to the action of internal stress of the DLC layer formed on a surface of the nitride layer can be produced.

### BRIEF DESCRIPTION OF DRAWINGS

FIG. 1A is a perspective view showing a portion of a ceramic cutting knife according to an embodiment of the present invention.

FIG. 1B is a schematic view of an A-A section in FIG. 1A.

FIG. 2 is a schematic cross-sectional view showing a stress state in a ceramic cutting knife according to an embodiment of the present invention.

FIG. 3 is a schematic cross-sectional view showing a stress state in a ceramic cutting knife according to an embodiment of the present invention.

FIGS. 4(a) and 4(e) are schematic cross-sectional views showing a process for producing a ceramic cutting knife according to an embodiment of the present invention.

FIGS. 5(a) to 5(e) are schematic cross-sectional views showing a process for producing a ceramic cutting knife according to an embodiment of the present invention.

### DESCRIPTION OF EMBODIMENTS

### <Ceramic Cutting Knife>

A ceramic cutting knife according to an embodiment of the present invention is described in detail below with reference to the drawings.

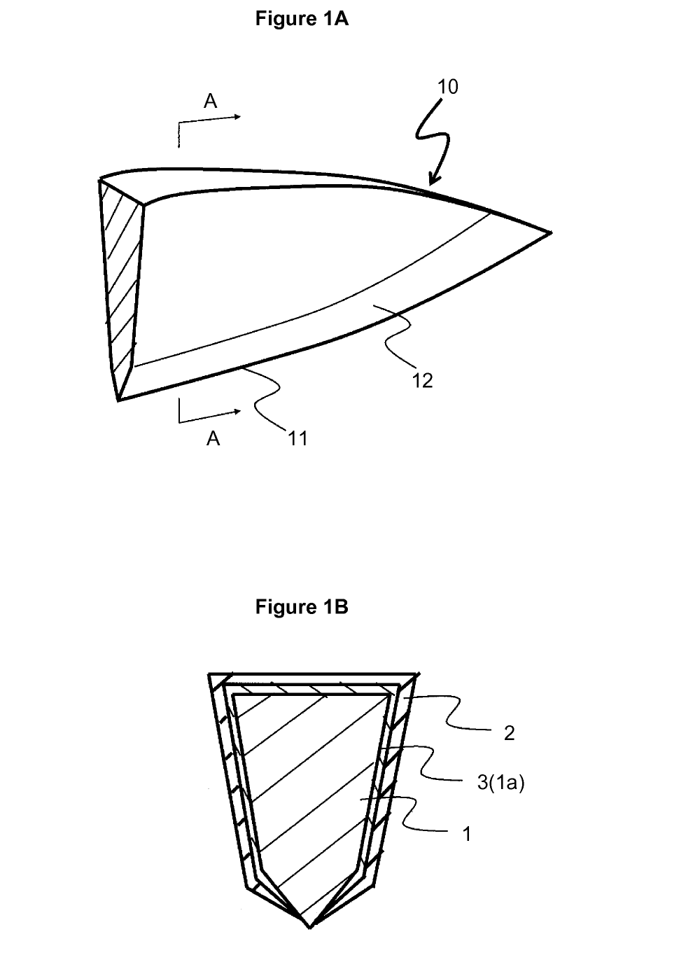

As shown in FIGS. 1A and 1B, the ceramic cutting knife according to the embodiment includes: a zirconia ceramic base member 1 including a cutting edge portion 1; a nitride layer 3 (1a) formed on a surface of the cutting edge portion 12; and a DLC layer 2 formed on a surface of the nitride layer 3 (1a). Since the nitride layer 3 is disposed between the zirconia ceramic base member 1 and the DLC layer 2, adhesion between the zirconia ceramic base member 1 and the DLC layer 2 can be improved.

In the embodiment, further, as shown in FIG. 1B, the DLC layer 2 is formed in a portion excluding the cutting edge 11 of the cutting edge portion 12 shown in FIG. 1A. That is, in the embodiment, the cutting edge 11 of the cutting edge portion 12 is exposed.

An knife using zirconia ceramic as the base member 1 is not only rustproof but also hardly broken due to higher toughness than in the use of other ceramics, and zirconia ceramics are suitable as materials for kitchen knives in view of high sliding properties.

The DLC layer 2 includes an amorphous structure containing hydrogen. Therefore, the stable DLC layer 2 can be formed because liberation of carbon from DLC can be reduced.

The formation of such DLC layer 2 can be analyzed by structural analysis, for example, with a solid-state nuclear magnetic resonance method (NMR). For example, in the case of DLC, peaks due to SP² carbon and SP³ carbon are observed near 136 ppm and 55 ppm, respectively, in a solid-state ¹³C NMR spectrum.

In addition, SP³ carbon is changed by about 20 to 40% with an increase in deposition electric power, and accordingly, shifts of the peaks may be observed. A shift of the SP² peak represents a portion having a structure close to graphite, and a shift of the SP³ peak reflects an increase or decrease of quaternary carbon observed near 62 ppm.

The DLC layer 2 may be formed at the cutting edge 11 portion. In this case, the DLC layer is removed, for example, using a grinder containing diamond abrasive grains.

When DLC is deposited on an iron surface, carbon is liberated from DLC and bonded to iron, thereby embrittling DLC. Therefore, it is undesirable to use DLC for iron.

Although the DLC layer 2 is transparent, the nitride layer 3 (1a) is black and thus a state of sharpening of the cutting edge 11 can be visually confirmed by a contrast between black of the nitride layer 3 (1a) and white of the zirconia ceramic base member 1.

In the embodiment, as described above, the cutting edge 11 of the cutting edge portion 12 is exposed. That is, the nitride layer 3 (1a) and the DLC layer 2 are formed on a surface excluding the cutting edge 11, but only the nitride layer 3(1a) may be formed on the cutting edge 11. Since the DLC layer 2 is not formed on the cutting edge 11, the cutting edge 11 can be polished even with a grindstone with low hardness, and the DLC layer 2 can be prevented from peeling starting at the periphery of the cutting edge 11. This can result in a ceramic cutting knife 10 having hardness and sliding properties equal to or higher than those of zirconia ceramics even in long-term use, reduction in a nick or the like, and retention of the ease of cutting food.

Here, the term “cutting edge 11” refers to the ridge side of the cutting edge portion 12, and the cutting edge 11 is generally within the range of a smaller blade of the cutting edge portion 12.

The “smaller blade” refers to a portion where the cutting edge angle in the cutting edge portion 12 is increased, and an area to be polished with a grindstone is the area of the smaller blade at a large inclination angle.

The periphery of the DLC layer 2 preferably gradually decreases in thickness within the range of the smaller blade of the cutting edge portion 12. Therefore, the periphery of the DLC layer 2 is inclined, and thus peeling from the periphery can be further reduced, improving corrosion resistance.

A material used for the nitride layer 3 may include, zirconium nitride (for example, ZrN), silicon nitride (for example, SiN), aluminum nitride (for example, AlN), and the like, and in particular, these materials preferably have stoichiometric ratios in view of corrosion resistance.

The nitride layer 3 preferably contains zirconium nitride in view of adhesion to the DLC layer 2.

For example, when ZrN is formed on the zirconia ceramic base member 1, adhesion can be strengthened by bonding between Zr element of the zirconia ceramic base member 1 and Zr element of the nitride layer 3 (1a), bonding between O element of the zirconia ceramic base member 1 and Zr element of the nitride layer 3 (1a), bonding between Zr element of the zirconia ceramic base member 1 and N element of the nitride layer 3 (1a), or bonding between O element of the zirconia ceramic base member 1 and N element of the nitride layer 3 (1a).

Even when the nitride layer 3 (1a) is composed of nitride 3 (1a) not containing Zr element, such as silicon nitride (for example, SiN) and aluminum nitride (for example, AlN), adhesion can be strengthened by bonding between Zr element of the zirconia ceramic base member 1 and N element of the nitride layer 3 (1a), bonding between O element of the zirconia ceramic base member 1 and Si or Al element of the nitride layer 3 (1a), or covalent bonding between O element of the zirconia ceramic base member 1 and N element of the nitride layer 3 (1a).

The DLC layer 2 formed on the nitride layer 3 (1a) by vapor deposition is strongly bonded by covalent bonding between C element of the DLC layer 2 and N element of the nitride layer 3 (1a), thereby strengthening adhesion.

In addition, even when the DLC layer 2 is removed from the cutting edge 11 by sharpening the cutting edge 11, hydrothermal degradation, which is a problem peculiar to zirconia ceramics, can be decreased because the zirconia ceramic base member 1 is coated with the nitride layer 1a.

Further, according to the embodiment, the thickness of the nitride layer 3 is equal to or smaller than the thickness of the DLC layer 2.

A relation of thickness between the nitride layer 3 (1a) and the DLC layer 2 is preferably a relation of thickness in which liberation of carbon from the DLC layer 2 can be decreased by the nitride layer 3 (1a).

Even when the thickness of the nitride layer 3 (1a) is equal to or larger than the thickness of the DLC layer 2, the effect of decreasing liberation of carbon from the DLC layer is not changed, but in this case, the nitride layer 3 (1a) conversely becomes weak as a base member.

Further, according to the embodiment, the ratio of the thickness of the nitride layer 3 to the thickness of the DLC layer 2 is 1:1 to 1:10. At a ratio within this range, adhesion of the zirconia ceramic base member 1 and the nitride layer 3 (1a) to the DLC layer 2 can be maintained, and hardness and sliding properties can be secured.

Further, according to the embodiment, the thickness of the nitride layer is 0.1 to 1 μm. With a thickness within this range, it is possible to improve adhesion of the DLC layer 2, secure the hardness and sliding properties, and decrease hydrothermal degradation of the knife 10.

Further, according to the embodiment, the thickness of the DLC layer 2 is 0.1 to 10 μm. With a thickness within this range, the DLC layer 2 functions as a stress layer, and thus bending strength can be improved.

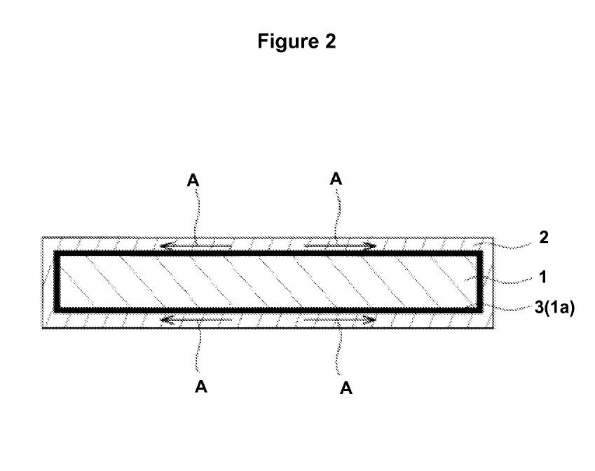

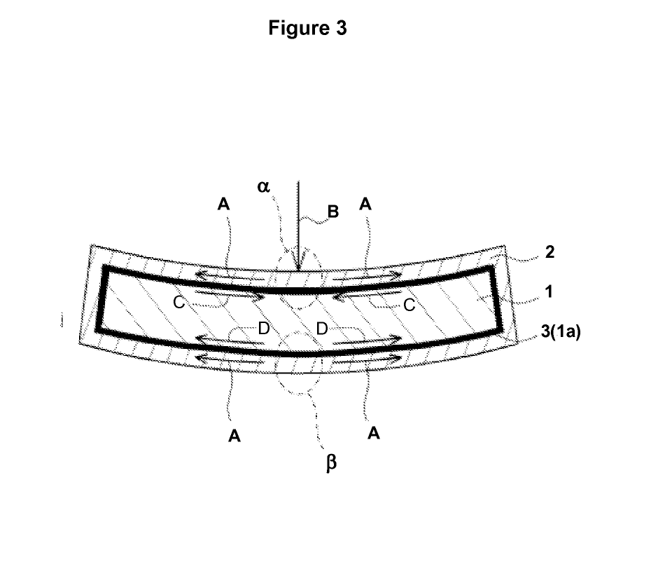

That is, as shown in FIG. 2, the DLC layer 2 has stress in a direction of arrow A, and when external force is applied to one of the surfaces of the DLC layer 2 in a direction of arrow B (vertical direction) as shown in FIG. 3, stress is produced in a direction of arrow C in a region a around a portion to which the external force is applied. The stress in the direction of arrow C can be canceled by the stress in the direction of arrow A possessed by the DLC layer 2, and thus the zirconia ceramic cutting knife 10 can be suppressed from reaching breakage.

On the other hand, stress is produced in a direction of arrow D in a region β which is opposite to the region α and which is the other surface opposite to the surface of the DLC layer 2 to which the external force is applied.

Also, the stress in the direction of arrow A possessed by the DLC layer 2 is applied to the region β, but the zirconia ceramic cutting knife 10 can be suppressed from reaching breakage because the volume of the region β is increased by phase transformation of zirconia crystal grains from the tetragonal to monoclinic phase (so-called stress-induced transformation).

In addition, with respect to the surface properties of the nitride layer 3 (1a), adhesion to the DLC layer 2 increases as the arithmetic mean surface roughness increases, but the surface properties of the nitride layer 3(1a) preferably have unevenness with such a height difference that the sliding properties of the DLC layer 2 are not degraded.

Also, the nitride layer 3 (1a) having a nitrogen concentration gradient in which the nitrogen concentration is high on the DLC layer 2 side exhibits good adhesion between the nitride layer 3 (1a) and the DLC layer 2.

Examples of the zirconia ceramic cutting knife 10 according to the present invention described above include a knife, a kitchen knife, a scissor, a peeler, and the like.

### <Method for Producing Ceramic Cutting Knife>

A method for producing the ceramic cutting knife according to a present embodiment of the present invention is described.

### (Raw Material)

A raw material for the base member of the zirconia ceramic cutting knife according to the embodiment contains zirconia as a main component and also contains yttria, silica, sodium oxide, and alumina at a specified ratio.

For example, specifically, 90% by mass or more and preferably 95% by mass or more of zirconia is contained, and as sintering aids, 1.5 to 3.5 mol % of yttria, 0.03% to 0.3% by mass of silica, 0.001% to 0.01% by mass of sodium oxide and 0.005% to 2% by mass alumina are contained.

Consequently, sinterability is improved, a uniform crystal structure can be easily formed, and decrease in fracture toughness of a zirconia sintered body can be suppressed.

Such zirconia raw material is produced by grinding, mixing and drying zirconia, yttria, silica, sodium oxide, and alumina, and has, for example, an average grain diameter of 0.4 to 1 μm, and a maximum grain diameter of 1 to 3 μm.

With the average grain diameter and the maximum grain diameter within the above-described respective ranges, a decrease in density of a molded product of the zirconia raw material after drying can be suppressed, and thus a dense sintered body can be easily produced.

The average grain diameter and the maximum grain diameter are values obtained by measurement with a laser diffraction-type grain size analyzer after a small amount of the zirconia raw material is added to water and a proper dispersant is added and sufficiently dispersed with an ultrasonic washing machine.

When the specific surface area is, for example, 4 to 16 m²/g, decrease in sinterability and sintered density can be suppressed, and a decrease in compact density can be suppressed.

The specific surface area is a value obtained by measurement by a BET single-point method.

The zirconia raw material described above can be produced through a step of grinding and mixing zirconia, yttria, silica, sodium oxide, and alumina, and a subsequent step of drying the resultant mixture.

A method for producing zirconia used as a base raw material is not particularly limited, and it can be produced by using a known method, for example, a coprecipitation method, a hydrolysis method, a hydrothermal method, or the like.

In addition, yttria, silica, sodium oxide, and alumina may be ground and mixed in an oxide form or may be contained as components in zirconia like in yttria stabilized zirconia (YSZ), and the YSZ may be mixed after being ground.

Grinding and mixing can be performed with, for example, a beads mill, a ball mill, a vibration mill, or the like, and a proper grinding and mixing time is about 1 to 10 hours.

In addition, wet-grinding with a solvent may be performed, and for example, water, an organic solvent, and the like can be used as the solvent, the organic solvent includes, for example, ethanol, acetone, isopropyl alcohol, and the like, and addition is preferable at a ratio of 40% to 60% by mass in terms of solid content of slurry after wet grinding.

According to a molding method, a binder such as polyvinyl alcohol, methyl cellulose, or the like can be added to the slurry after wet grinding.

When grindability is decreased due to high viscosity, a dispersant may be added, and the dispersant includes, for example, polyethylene glycol, ammonium polyacrylate, ammonium polycarboxylate, sodium hexametaphosphate, and the like.

A drying method is not particularly limited, and a drying method generally used by persons skilled in the art can be used.

For example, drying in a nitrogen atmosphere using a dryer, a spray drying method (spray dry method), and the like can be used, and the spray drying method is preferred in view of efficient preparation of the raw material.

In the use of the spray drying method, the hot-air temperature of a spray dryer is preferably 150° C. to 250° C., and a dry powder after drying is preferably graded through a sieve of about 80 to 200 mesh.

On the other hand, in the use of a dryer or the like, the drying temperature is appropriately about 100° C. to 200° C., and the raw material after drying is preferably disintegrated using a pin mill or the like.

In the zirconia raw material after drying, in general, zirconia and yttria are in a solid-solution state, and silica, sodium oxide, and alumina are in a mixed state.

### (Molding and Sintering Step)

A zirconia sintered body can be formed through a step of forming a molded product from the zirconia raw material and a step of sintering the molded product.

In order to form the molded product from the zirconia raw material, a known molding method, for example, cast molding, injection molding, extrusion molding, compression molding, die molding, or the like, can be used.

In particular, in the use of compression molding, CIP molding is preferred for forming a homogeneous molded product with high density, and the molding pressure is appropriately about 50 to 200 MPa.

In addition, pre-molding may be performed using a uniaxial compression molding machine or the like before CIP molding. In the use of die molding, the molding pressure is appropriately about 50 to 100 MPa.

The molded product is preferably fired at 1300° C. to 1600° C., preferably 1350° C. to 1450° C., for about 1 to 3 hours.

This firing can suppress an increase in crystal grain boundaries and suppress a decrease in strength in a hydrothermal degradation environment.

Also, in the use of the zirconia raw material containing a binder added thereto, debinding is preferably performed at 350° C. to 600° C.

Debinding within this range can suppress the binder from remaining or suppress the occurrence of a crack in the molded product due to rapid debinding.

In addition, a firing atmosphere may be vacuum or the like for decreasing pores in the sintered body as well as air.

### (Surface Processing Step)

In a present embodiment, there are a first step of forming the nitride layer on a surface of the cutting edge portion of the zirconia ceramic base member having the cutting edge portion by a sputtering method or ion implantation method, and a second step of forming the DLC layer on a surface of the nitride layer.

In the production method according to the embodiment of the present invention, the zirconia ceramic base member 1, which is produced as a blade body of a knife by cutting, polishing, and sharpening the sintered body, is subjected to a treatment described below.

That is, there are a first step of forming the nitride layer 3 (1a) on a surface of the cutting edge portion 12 of the zirconia ceramic base member 1 having the cutting edge portion 12 by a sputtering method or ion implantation method, and a second step of forming the DLC layer 2 on a surface of the nitride layer 3 (1a).

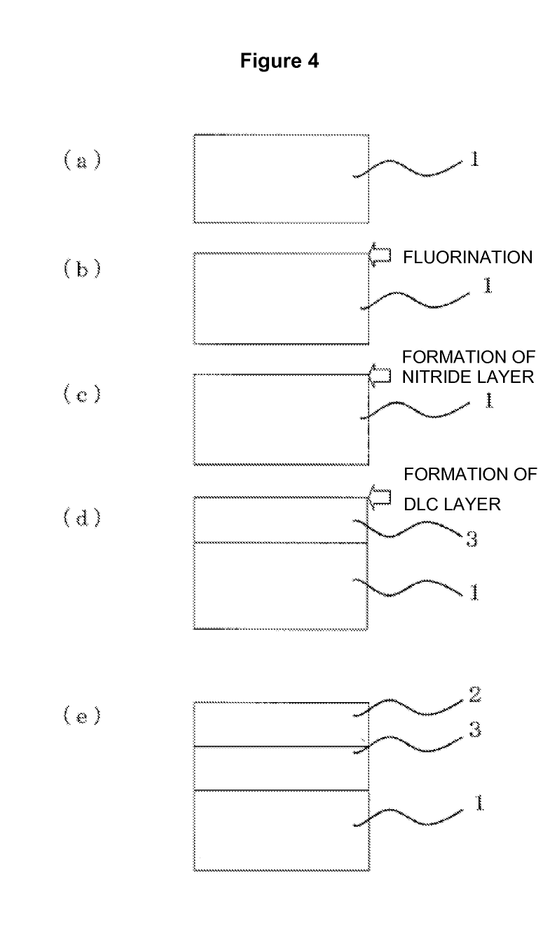

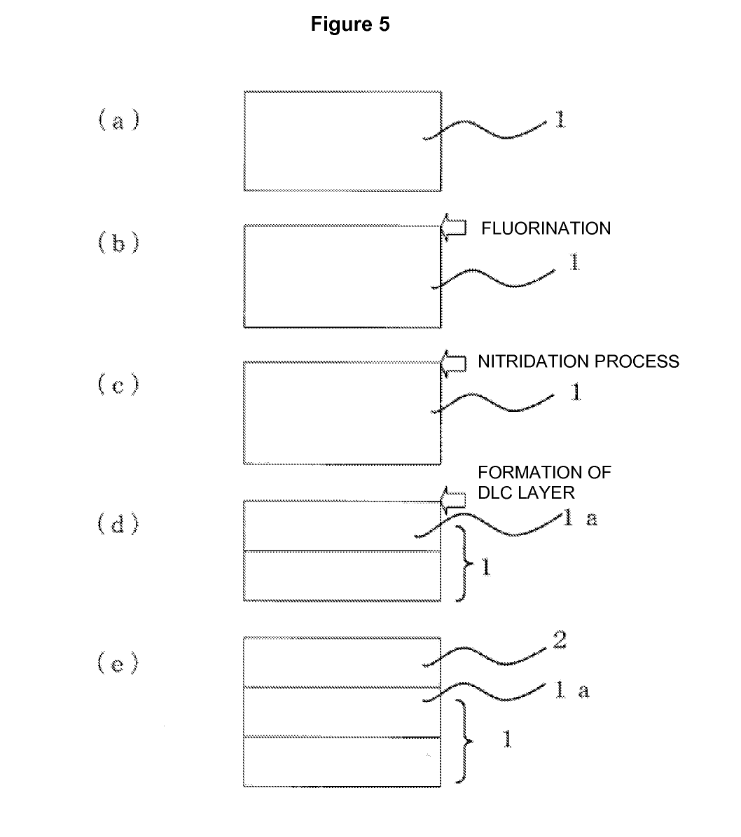

A production process until forming the DLC layer 2 on the zirconia ceramic base member 1 is described below with reference to FIGS. 4(a) to 4(e) and 5(a) to 5(e).

First, a surface of the zirconia ceramic base member 1 serving as a blade body shown in FIGS. 4A and 5A are fluorinated to remove foreign matters as shown in FIGS. 4B and 5B.

This permits the formation of the uniform nitride layer 3 (1a).

Next, a nitride layer 3 is formed on the surface of the zirconia ceramic base member 1 by a vapor deposition method or sputtering method as shown in FIG. 4C, or as shown in FIG. 5C, a nitride layer 3 (1a) is formed on a surface of the zirconia ceramic base member 1 by bombardment in a nitrogen atmosphere or a nitrogen ion implantation method (refer to FIGS. 4D and 5D). The treatment shown in FIGS. 5(c) and 5(d) strengthens adhesion between the zirconia ceramic base member 1 and the nitride layer 1a.

In an embodiment, the nitride layer is formed by the bombardment or the nitrogen ion implantation method in a high frequency of 20 kHz at 100 to 200 V for 10 to 30 minutes and a pressure of 2 to 20 Pa in a nitrogen gas atmosphere.

Then, the DLC layer 2 as shown in FIGS. 4(e) and 5(e) can be formed by a reactive CVD method or the like.

As conditions for deposition by the CVD method, formed in a treatment temperature of 20° C. to 200° C. in a plasma CVD method, a deposition power of RF 1 to 5 kW for 10 to 40 minutes, and a pressure of 2 to 20 Pa in a gas atmosphere containing 60 to 80% of methane and 20 to 40% of hydrogen.

Further, in the embodiment, a masking material (not shown) is applied to the cutting edge 11 of the cutting edge portion 12 between the first and second steps.

Regarding a masking method, for example, a solution of 20% by mass of novolac resin in ethanol is applied onto a sheet with a predetermined thickness, and then the cutting edge 11 is brought into contact with the surface of the sheet.

As a result, the nitride layer 3 (1a) is exposed from the DLC layer 2 at the surface of the cutting edge 11, producing a black surface of the cutting edge 11.

Therefore, when the cutting edge portion 12 is polished separately, a boundary between a polished region (white) and an unpolished region (black) can be distinctively determined by visual observation.

When separate polishing of the cutting edge portion 12 is not considered, a masking material may be previously applied along the cutting edge of the cutting edge portion 12 before the first step.

Although the present invention and embodiments thereof are described in further detail below with reference to examples, the present invention and the embodiments thereof are not limited to these examples.

### Example

### (Preparation of Sample)

In an example, a zirconia ceramic cutting knife containing 2 mol % of yttria, 0.2% by mass of silica, 0.005% by mass of sodium oxide, 1% by mass of alumina, and the balance of zirconia was prepared as a base member 1.

This was produced by compression molding at a molding pressure of 100 MPa, and firing was performed at 1450° C. for 2 hours (Sample Nos. 3 to −22).

In the example, the nitride layers 3 (1a) were divided into ones formed by a sputtering method (Sample Nos. 3 to 5) and ones formed by an ion implantation method (Sample Nos. 6 to 22) with thicknesses shown in Table 1.

The DLC layers 2 were formed by a reactive CVD method to the thickness shown in Table 2 (Sample Nos. 3 to 22).

Sample Nos. 6 and 9 were formed under the same conditions and Sample Nos. 16 and 21 were formed under the same conditions as a matter of convenience.

In comparative examples (Sample Nos. 1, 2, and 23 to 25), it is divided such that the base member 1 was composed of silicon nitride ceramic (Sample No. 1) and the base member 1 was composed of zirconia ceramic (Sample Nos. 2 and 23 to 25).

Next, according to the thicknesses shown in Table 1, it is divided such that a titanium layer was formed by a sputtering method (Sample No. 2), the nitride layer 3 (1a) was formed by the ion implantation method (Sample No. 24), and the under layer 1a (3) was not formed (Sample Nos. 1, 23, and 25).

Also, according to the materials and thicknesses shown in Table 1, it is divided such that the DLC layer 2 was formed by a reactive CVD method (Sample Nos. 1, 2, and 23) and the DLC layer 2 was not formed (Sample Nos. 24 and 25).

Sample No. 25 was a zirconia ceramic kitchen knife without the nitride layer 3 (1a) and the DLC layer 2.

### (Sample Evaluation)

For each zirconia ceramic kitchen knife after a hydrothermal degradation test (100° C. for 2 hours), hardness and sliding properties, and adhesion of the DLC layer 2 were evaluated by measuring 100 times the number of sheets of paper cut at a time using a Honda-type cutting tester (load of 100 N at the tip of the knife) and averaging the numbers.

For the zirconia ceramic kitchen knife after a hydrothermal degradation test (100° C. for 2 hours), strength was evaluated by 3-point bending strength (flexural strength) according to JIS 1601.

The results are shown in Table 1 below.

TABLE 1

| | | | | | | Thickness ratio | Number of | |
|---|---|---|---|---|---|---|---|---|
| | | Under layer (nitride layer) | | | DLC layer | Under layer | sheets | Flexural |
| Sample | Base | | | Thickness | Thickness | (nitride | measured by | strength |
| No. | member | Material | Treatment method | (m) | (m) | layer):DLC layer | cutting tester | (MPa) |
| *1 | Silicon | None | — | 1 | 1 | 1:1 | 120 | 600 |
| | nitride | | | | | | | |
| *2 | Zirconia | Titanium | Sputtering | 1 | 1 | 1:2 | 60 | 900 |
| *3 | Zirconia | Silicon nitride | Sputtering | 1 | 1 | 1:3 | 140 | 1000 |
| 4 | Zirconia | Aluminum nitride | Sputtering | 1 | 1 | 1:4 | 140 | 1000 |
| 5 | Zirconia | Zirconium nitride | Sputtering | 1 | 1 | 1:5 | 140 | 1200 |
| 6 | Zirconia | Zirconium nitride | Ion implantation | 1 | 1 | 1:6 | 140 | 1200 |
| 7 | Zirconia | Zirconium nitride | Ion implantation | 0.05 | 1 | 1:20 | 120 | 1000 |
| 8 | Zirconia | Zirconium nitride | Ion implantation | 0.1 | 1 | 1:10 | 140 | 1200 |
| 9 | Zirconia | Zirconium nitride | Ion implantation | 1 | 1 | 1:1 | 140 | 1200 |
| 10 | Zirconia | Zirconium nitride | Ion implantation | 2 | 1 | 1:0.5 | 120 | 1000 |
| 11 | Zirconia | Zirconium nitride | Ion implantation | 1 | 0.05 | 1:0.05 | 120 | 1000 |
| 12 | Zirconia | Zirconium nitride | Ion implantation | 1 | 0.1 | 1:0.1 | 120 | 1200 |
| 13 | Zirconia | Zirconium nitride | Ion implantation | 1 | 10 | 1:10 | 140 | 1200 |
| 14 | Zirconia | Zirconium nitride | Ion implantation | 1 | 20 | 1:20 | 120 | 1000 |
| 15 | Zirconia | Zirconium nitride | Ion implantation | 0.05 | 10 | 1:200 | 120 | 1000 |
| 16 | Zirconia | Zirconium nitride | Ion implantation | 0.1 | 10 | 1:100 | 120 | 1200 |
| 17 | Zirconia | Zirconium nitride | Ion implantation | 1 | 10 | 1:10 | 140 | 1200 |
| 18 | Zirconia | Zirconium nitride | Ion implantation | 2 | 10 | 1:5 | 120 | 1000 |
| 19 | Zirconia | Zirconium nitride | Ion implantation | 0.1 | 0.05 | 1:0.5 | 120 | 1000 |
| 20 | Zirconia | Zirconium nitride | Ion implantation | 0.1 | 0.1 | 1:1 | 140 | 1200 |
| 21 | Zirconia | Zirconium nitride | Ion implantation | 0.1 | 10 | 1:100 | 120 | 1200 |
| 22 | Zirconia | Zirconium nitride | Ion implantation | 0.1 | 20 | 1:200 | 120 | 1000 |
| *23 | Zirconia | No | — | 0 | 1 | — | 40 | 950 |
| *24 | Zirconia | Zirconium nitride | Ion implantation | 1 | 0 | — | 30 | 900 |
| *25 | Zirconia | No | — | 0 | 0 | — | 40 | 800 |

Mark * indicates a sample out of the scope of the example of the present invention.

Sample Nos. 3 to 22 of the example could produce desired results of sharpness and flexural strength, and in particular, Samples Nos. 5, 6, 8, 9, 13, 17, and 20 showed good results.

Here, the excessively thin nitride layer 3 (1a) showed the tendency of adhesion to the DLC layer 2 to be degraded was observed, but this was within a usable range (Sample No. 7).

The excessively thick nitride layer 3 (1a) showed the tendency of adhesion between the zirconia ceramic base member 1 and the DLC layer 2 to be degraded due to internal stress of the nitride layer 3 (1a), but this was within a usable range (Sample No. 10).

The excessively thin DLC layer 2 showed the tendency of the DLC layer 2 at the cutting edge 11 to easily peel, but this was within a usable range (Sample No. 11).

The excessively thick DLC layer 2 showed the tendency of the cutting edge 11 to be difficult to sharpen, but this was within a usable range (Sample No. 14).

On the other hand, Sample No. 1 of the comparative example exhibited satisfactory cutting quality, but exhibited poor bending strength and was intolerable to use as a kitchen knife.

This is because silicon nitride has excessively high hardness, and toughness is lower than that of zirconia.

Sample Nos. 2 and 23 of the comparative example showed sharpness and bending strength equivalent to those of a conventional zirconia ceramic kitchen knife (Sample No. 25) because of peeling of the DLC layer 2.

This is because the DLC layer 2 easily peels due to entrance of water from the worn cutting edge portion 12.

In addition, Sample No. 24 showed sharpness and bending strength equivalent to those of a conventional zirconia ceramic kitchen knife (Sample No. 25) because of the absence of the DLC layer 2.

A comparison between Sample Nos. 6 and 24 reveals that bending strength of the zirconia ceramic kitchen knife is improved by the action of internal stress of the DLC layer 2 formed on the surface of the nitride layer 3 (1a).

### REFERENCE SIGNS LIST

1: zirconia ceramic base member
1a: nitride layer
2: DLC (diamond-like carbon) layer
3: nitride layer
10: edged tool
11: cutting edge
12: cutting edge portion

1. A ceramic cutting knife comprising:
a zirconia ceramic base member comprising a cutting edge and a cutting edge portion that is an adjacent area of the cutting edge;
a nitride layer on the cutting edge portion; and
a diamond-like carbon layer on the nitride layer.

2. The ceramic cutting knife according to claim 1, wherein the diamond-like carbon layer comprises an amorphous carbon structure containing hydrogen.

3. The ceramic cutting knife according to claim 1, wherein the cutting edge comprises no diamond-like carbon layer thereon.

4. The ceramic cutting knife according to claim 1, wherein the nitride layer comprises zirconium nitride.

5. The ceramic cutting knife according to claim 1, wherein the thickness of the nitride layer is equal to or smaller than the thickness of the diamond-like carbon layer.

6. The ceramic cutting knife according to claim 5, wherein a ratio of the thickness of the nitride layer to the thickness of the diamond-like carbon layer is 1:1 to 1:10.

7. The ceramic cutting knife according to claim 5, wherein the thickness of the nitride layer is 0.1 to 1 μm.

8. The ceramic cutting knife according to claim 5, wherein the thickness of the diamond-like carbon layer is 0.1 to 10 μm.

9. A method for producing a ceramic cutting knife comprising:
preparing a base member containing zirconia ceramic and comprising a cutting edge and a cutting edge portion that is an adjacent area of the cutting edge;
forming a nitride layer on the cutting edge portion of the base member; and
forming a diamond-like carbon layer on a surface of the nitride layer.

10. The method according to claim 9, further comprising coating a masking material on the cutting edge before forming the diamond-like carbon layer.

11. The method according to claim 11, wherein the nitride layer is formed a sputtering method or ion implantation method.

12. A ceramic edged tool comprising:
a base member;
a cutting edge at a side of the base member, comprising no diamond-like carbon layer thereon; and
a non-edge portion that is a portion of the base member other than the cutting edge, the non-edge portion comprising:
a nitride layer on at least a part thereof; and
a diamond-like carbon layer on the nitride layer.

13. The ceramic edged tool according to claim 12, wherein the cutting edge further comprises a nitride layer thereof.

14. The ceramic edged tool according to claim 12, wherein the base member comprises zirconia.
